(19) United States
(12) Patent Application Publication
(10) Pub. No.: US 2017/0080781 A1
(43) Pub. Date: Mar. 23, 2017

(54) AIR VENT FOR VEHICLE

(71) Applicants: Hyundai Motor Corporation, Seoul (KR); Kia Motors Corporation, Seoul (KR)

(72) Inventors: Jungmo Kwak, Gunpo (KR); Moo Yong Kim, Suwon (KR); Myung Hoe Kim, Seoul (KR); Sang Shin Lee, Suwon (KR)

(21) Appl. No.: 14/937,471

(22) Filed: Nov. 10, 2015

(30) Foreign Application Priority Data
Sep. 23, 2015 (KR) 10-2015-0134958

(51) Int. Cl. B60H 1/34; B60H 1/00

(52) U.S. Cl. CPC B60H 1/3421; B60H 1/00064; B60H 2001/3478; B60H 2001/3485; B60H 2001/00192

(57) ABSTRACT

An air vent for a vehicle supplies air generated from a Heating, Ventilation, and Air Conditioning (HVAC) system into an interior of the vehicle. The air vent may include: a first supply duct communicated with the HVAC system; a second supply duct communicated with the HVAC system; a vent body communicated with the first supply duct and the second supply duct; a first discharging duct always communicated with the first supply duct through the vent body; a second discharging duct always communicated with the second supply duct through the vent body; and a central discharging duct selectively communicated with the first supply duct or the second supply duct through the vent body.

### CROSS-REFERENCE TO RELATED APPLICATION

This application claims under 35 U.S.C. §119(a) the benefit of Korean Patent Application No. 10-2015-0134958 filed in the Korean Intellectual Property Office on Sep. 23, 2015, the entire contents of which are incorporated herein by reference.

### BACKGROUND

(a) Field of the Invention

The present invention relates to an air vent for a vehicle, more particularly, to an air vent for a vehicle which is configured to supply air having a temperature required by a passenger.

(b) Description of the Related Art

Generally, an HVAC (Heating, Ventilation, Air Conditioning) system, which performs heating, ventilation, and air conditioning, is provided in a vehicle for providing indoor air corresponding with temperature requirements of passengers.

The HVAC system communicates with an interior of a vehicle through an air vent, which controls an amount of discharge air and a discharge direction.

The air vent includes blades which are disposed at a duct being communicated with the interior of a vehicle or an outlet of the duct so as to guide a discharge direction of air. The blades may include a plurality of horizontal blades which are horizontally arranged for altering a discharge direction of air to up and down directions and a plurality of vertical blades which are vertically arranged for altering a discharge direction of air to right and left directions.

HVAC systems have been developed for performing heating, ventilation, and air conditioning depending on individual requirements of each passenger seated a driver's seat, a front passenger seat, and a back seat, respectively, and a design of the air vent has become important for realizing this performance.

However, production cost and a manufacturing process may be deteriorated if the structure of the duct and the blade of the air vent become complex for satisfying each passenger.

The above information disclosed in this Background section is only for enhancement of understanding of the background of the invention and therefore it may contain information that does not form the prior art that is already known in this country to a person of ordinary skill in the art.

### SUMMARY

The present invention has advantages of improving satisfaction of passengers regarding air supplied into an interior of a vehicle, by utilizing a simple structure of an air vent.

An air vent for a vehicle according to an exemplary embodiment of the present invention may be configured to supply air generated from a Heating, Ventilation, and Air Conditioning (HVAC) system into an interior of the vehicle. The air vent may include: a first supply duct communicated with the HVAC system; a second supply duct communicated with the HVAC system; a vent body communicated with the first supply duct and the second supply duct; a first discharging duct always communicated with the first supply duct through the vent body; a second discharging duct always communicated with the second supply duct through the vent body; and a central discharging duct selectively communicated with the first supply duct or the second supply duct through the vent body.

The central discharging duct may be disposed between the first discharging duct and the second discharging duct, and the central discharging duct may not be communicated with the first supply duct or not be communicated with the second supply duct depending on operation of a valve.

The first supply duct may receive air that satisfies a first condition from the HVAC system, and the second supply duct may receive air that satisfies a second condition from the HVAC system.

A blade for guiding a direction of discharged air may be disposed at an outlet of the central discharging duct, and the valve and the blade may be rotatably connected by at least one link making a lever motion.

The blade may be a vertical blade for altering a direction of discharged air to right and left directions, and the links connecting the valve with the blade may be sequentially connected such that a rotating direction of the blade is opposite to a rotating direction of the valve.

The air vent may further include: a vent knob provided to be handled by a passenger at an outlet of the central discharging duct; a plurality of vertical blades vertically arranged at the outlet of the central discharging duct so as to alter a direction of discharged air to right and left directions by handling the vent knob; a valve being operated so as to selectively communicate the central discharging duct with the first supply duct or the second supply duct; and an operation link connecting the vertical blade with the valve such that the valve is operated according to operation of the vertical blade by handling the vent knob.

The operation link may include: a first link rotatably connected with a first hinge member which is vertically protruded from a blade connecting member for connecting the vertical blades to be in synchronization with each other; a second link rotatably connected with the first link; and a third link rotatably connected with the second link and integrally moved together with the valve.

The vertical blade, the first link, the second link and the third link may sequentially make a lever motion by handling the vent knob, and the valve may rotate together with the third link so as to selectively block the communication between the first supply duct and the central discharging duct or the communication between the second supply duct and the central discharging duct.

The valve may be formed in a wide plate shape so as to block the communication between the first supply duct and the central discharging duct or the communication between the second supply duct and the central discharging duct.

### BRIEF DESCRIPTION OF THE DRAWINGS

FIG. 1 is a perspective view of an air vent for a vehicle according to an exemplary embodiment of the present invention.

FIG. 2 and FIG. 3 are perspective views of a structure of an operation link for operating an air vent for a vehicle according to an exemplary embodiment of the present invention.

FIG. 4 and FIG. 5 are operational views of an air vent for a vehicle according to an exemplary embodiment of the present invention.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

An exemplary embodiment of the present invention will hereinafter be described in detail with reference to the accompanying drawings.

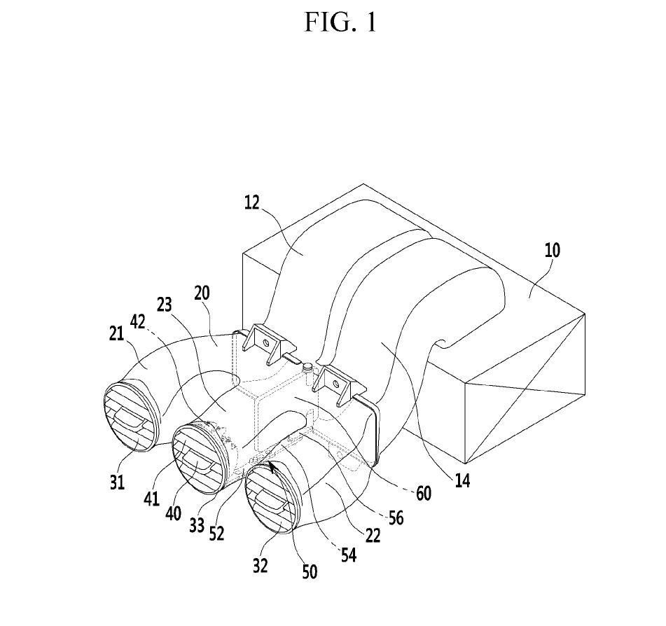

FIG. 1 is a perspective view of an air vent for a vehicle according to an exemplary embodiment of the present invention.

As shown in FIG. 1, an air vent for a vehicle according to an exemplary embodiment of the present invention is communicated with an HVAC system 10, and includes a first supply duct 12, a second supply duct 14, a vent body 20, a first discharging duct 21, a second discharging duct 22, a central discharging duct 23, a first blade unit 31, a second blade unit 32, a central blade unit 33, an operation link 50, and a valve 60.

The HVAC system 10 generates air being supplied into an interior of a vehicle. In addition, the HVAC system 10 controls an amount and temperature of air being supplied into the interior depending on requirements of passenger(s). As used herein, the term “passengers” refers to a driver, front passenger, rear passenger(s), and other occupants of a vehicle. The HVAC system 10 is a system which performs Heating, Ventilation, and Air Conditioning and is well known to a person of an ordinary skill in the art, so the detailed description thereof will be omitted.

The first supply duct 12 is communicated with the HVAC system 10. In addition, the first supply duct 12 is an air passage which receives air that satisfies a first condition (e.g., either an amount or temperature of air) from the HVAC system 10. Herein, air having a predetermined (first) condition may be delivered to the first supply duct 12 according to the requirement of a driver, but it is not limited thereto.

The second supply duct 14 is communicated with the HVAC system 10. In addition, the second supply duct 14 is an air passage which receives air that satisfies a second condition (e.g., either an amount or temperature of air) from the HVAC system 10. Herein, air having a predetermined (second) condition may be delivered to the second supply duct 14 according to the requirement of a passenger seated in a front passenger seat, but it is not limited thereto. Merely, it will be described that the first supply duct 12 receives air according to the requirement of a driver and the second supply duct 14 receives air according to the requirement of a passenger seated in the front passenger seat for convenience of explanation. Further, the requirements of the driver and front passenger may be the same.

The vent body 20 is an air passage which receives air from the first supply duct 12 and the second supply duct 14, and is adapted that one end of the vent body 20 is communicated with the first supply duct 12 and the second supply duct 14. In addition, the other end of the vent body 20 is branched to three air passages.

The first discharging duct 21 is one of the three air passages branched from the vent body 20, and is disposed near a driver's seat. In addition, the first discharging duct 21 is always communicated with the first supply duct 12. Further, the first discharging duct 21 always receives air according to the requirement of a driver from the first supply duct 12 so as to discharge air into the interior of the vehicle.

The second discharging duct 22 is another one of the three air passages branched from the vent body 20, and is disposed near a front passenger seat. In addition, the second discharging duct 22 is always communicated with the second supply duct 14. Further, the second discharging duct 22 always receives air according to the requirement of a passenger seated in a front passenger seat from the second supply duct 14 so as to discharge air into the interior of the vehicle.

The central discharging duct 23 is an air passage which is disposed between the first discharging duct 21 and the second discharging duct 22 of the three air passages branched from the vent body 20. In addition, the central discharging duct 23 is selectively communicated with the first supply duct 12 or the second supply duct 14. That is, the central discharging duct 23 is communicated with one of the first supply duct 12 and the second supply duct 14 or is communicated with both. The selective communication of the central discharging duct 23 is realized by operation of an air vent for a vehicle according to an exemplary embodiment of the present invention to be described below.

The first blade unit 31 is disposed at an outlet of the first discharging duct 21. In addition, the first blade unit 31 guides a direction of air being discharged from the first discharging duct 21.

The second blade unit 32 is disposed at an outlet of the second discharging duct 22. In addition, the second blade unit 32 guides a direction of air being discharged from the second discharging duct 22.

The central blade unit 33 is disposed at an outlet of the central discharging duct 23. In addition, the central blade unit 33 guides a direction of air discharged from the central discharging duct 23.

The central blade unit 33 includes a vent knob 40, a horizontal blade 41, and a vertical blade 42.

The vent knob 40 is provided to be handled by a passenger.

The horizontal blades 41 are horizontally arranged by a plurality so as to alter an air discharged direction to up and down directions by handling the vent knob 40.

The vertical blades 42 are vertically arranged by a plurality so as to alter an air discharged direction to right and left directions by handling the vent knob 40.

The first and second blade units 31 and 33 may have similar structures, and a basic structure and operation of blade units 31, 32, and 33, which are adapted that inclination angles of the horizontal blade 41 and the vertical blade 42 are adjusted by handling the vent knob 40 so as to alter an air discharged direction, are well known to a person of an ordinary skill in the art, so the detailed description thereof will be omitted.

The operation link 50 is disposed in the central discharging duct 23 so as to be connected with the vertical blade 42, and the valve 60 is connected with the operation link 50. In addition, the valve 60 is moved by the operation link 50 as a driver handles the vent knob 40 such that the vertical blade 42 is moved. Further, the selective communication of the central discharging duct 23 is realized by operation of the valve 60.

Hereinafter, the operation of an air vent for a vehicle according to an exemplary embodiment of the present invention for selectively communicating the central discharging duct 23 with the first supply duct 12 or the second supply duct 14 will be described.

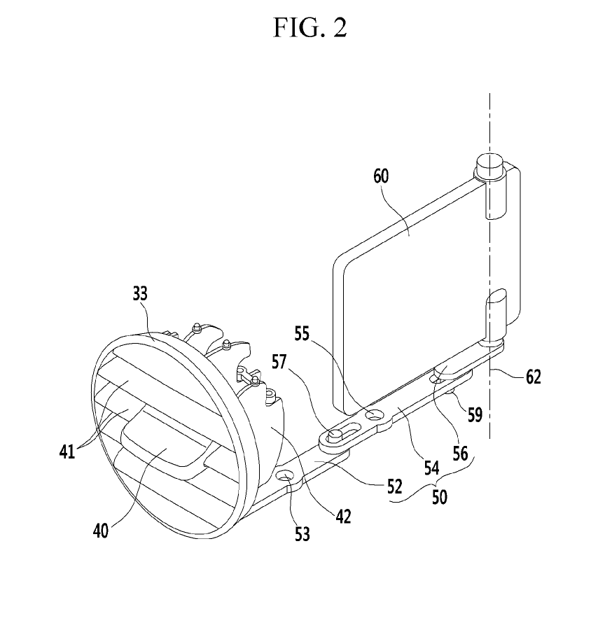

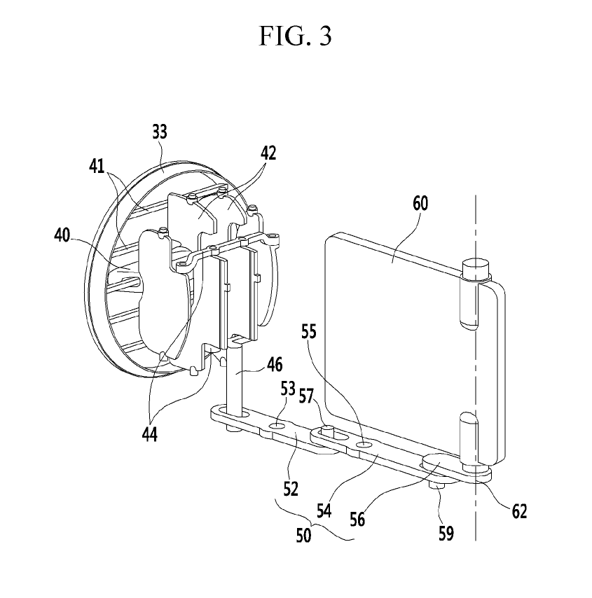

FIG. 2 and FIG. 3 are drawings showing the structure of an operation link for operating an air vent for a vehicle according to an exemplary embodiment of the present invention.

As shown in FIG. 2 and FIG. 3, the operation link 50 includes a first link 52, a second link 54, and a third link 56.

The first link 52 is connected with the vertical blade 42. In addition, the plurality of vertical blade 42 is connected to be operated to be in synchronization with each other by a blade connecting member 44, and one end of the first link 52 is rotatably connected with a first hinge member 46 vertically protruded from the blade connecting member 44. Further, a first lever pivot 53 is formed between the one end and the other end of the first link 52, and the first link 52 makes a lever motion around the first lever pivot 53 as the first hinge member 46 is moved together with the vertical blade 42. Meanwhile, the first lever pivot 53 may be connected with the central discharging duct 23 or the vent body 20 such that a phase thereof is not changed.

One end of the second link 54 is rotatably connected with a second hinge member 57 vertically protruded from the other end of the first link 52. In addition, a second lever pivot 55 is formed between the one end and the other end of the second link 54, and the second link 54 makes a lever motion around the second lever pivot 55 depending on the lever motion of the first link 52. Meanwhile, the second lever pivot 55 may be connected with the central discharging duct 23 or the vent body 20 such that a phase thereof is not changed. Herein, a rotating direction of the first link 52 and a rotating direction of the second link 54 by the lever motion are naturally opposite with each other.

A third hinge member 59 which is vertically protruded is formed at one end of the third link 56. In addition, the other end of the second link 54 is rotatably connected with the third hinge member 59. Further, a third lever pivot 62 is formed at the other end of the third link 56, and the third link 56 makes a lever motion around the third lever pivot 62 depending on the lever motion of the second link 54. Meanwhile, the third lever pivot 62 may be connected with the central discharging duct 23 or the vent body 20 such that a phase thereof is not changed. Herein, a rotating direction of the second link 54 and a rotating direction of the third link 56 by the lever motion are naturally opposite with each other.

The protruded portion and the portion seating the protruded portion may be switched in the connection of the first, second, and third hinge members 46, 57, and 59, and it may be variously designed by a person of an ordinary skill in the art to realize hinge connection.

The third lever pivot 62 is a rotation center of the valve 60, and the valve 60 integrally rotates together with the third link 56. In addition, the valve 60 is formed in a wide plate shape so as to block the communication between the first supply duct 12 and the central discharging duct 23 or the communication between the second supply duct 14 and the central discharging duct 23.

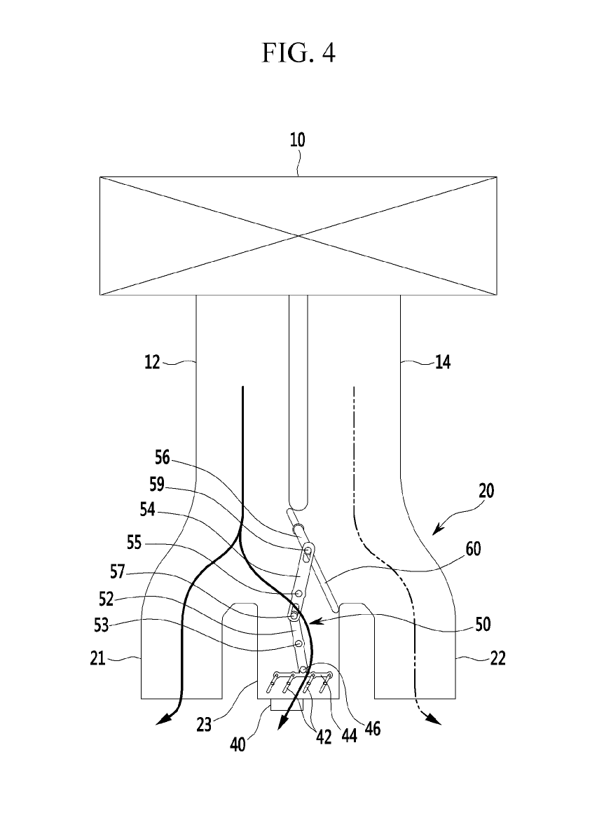

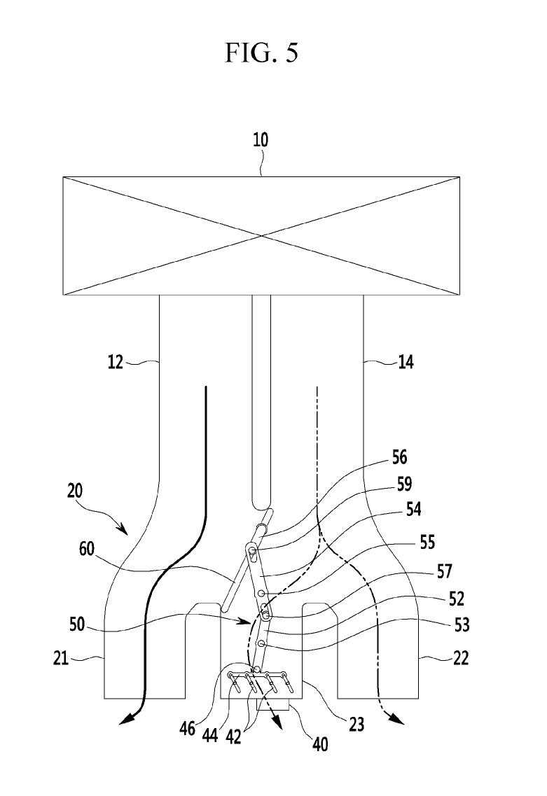

FIG. 4 and FIG. 5 are operational views of an air vent for a vehicle according to an exemplary embodiment of the present invention.

FIG. 4 shows that the valve 60 blocks the communication between the second supply duct 14 and the central discharging duct 23.

As shown in FIG. 4, as the blade connecting member 44 being moved together with the vertical blade 42 is connected with the third link 56 being moved together with the valve 60 by the two levers 52 and 54, the valve 60 is operated to block the communication between the second supply duct 14 and the central discharging duct 23 when the vertical blade 42 is operated to discharge air toward a driver's seat. That is, a rotating direction of the vertical blade 42 and a rotating direction of the valve 60 are opposite with each other. Thus, if the vertical blade 42 is operated to guide air toward a driver's seat, the first discharging duct 21 and the central discharging duct 23 receive air from the first supply duct 12 and discharge air into interior.

FIG. 5 shows that the valve 60 blocks the communication between the first supply duct 12 and the central discharging duct 23.

As shown in FIG. 5, the valve 60 is operated to block the communication between the first supply duct 12 and the central discharging duct 23 when the vertical blade 42 is operated to discharge air toward a front passenger seat. Thus, if the vertical blade 42 is operated to guide air toward a front passenger seat, the second discharging duct 22 and the central discharging duct 23 receive air from the second supply duct 14 and discharge air into interior.

Meanwhile, in case that the vertical blade 42 is not operated to one direction of a driver's seat or a front passenger seat, the central discharging duct 23 is communicated with both the first supply duct 12 and the second supply duct 14. Therefore, air may be discharged into an interior of the vehicle through the central discharging duct 23, based on conditions (e.g., amount, temperature) preset by the driver and front passenger. As a result, it is possible for air in the vehicle to approximately average the conditions preset by the driver and front passenger.

According to an exemplary embodiment of the present invention, air is discharged when the central discharging duct 23 is selectively communicated with the first supply duct 12 or the second supply duct 14 by the operation of the valve 60. In addition, satisfaction of passengers about supplied air can be improved by a simple structure as provided herein, where the operation link 50 is provided such that the vent knob 40 and the valve 60 are continuously operated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An air vent configured to supply air generated from a Heating, Ventilation, and Air Conditioning (HVAC) system into an interior of a vehicle, the air vent comprising:
a first supply duct communicated with the HVAC system;
a second supply duct communicated with the HVAC system;
a vent body communicated with the first supply duct and the second supply duct;
a first discharging duct always communicated with the first supply duct through the vent body;
a second discharging duct always communicated with the second supply duct through the vent body; and
a central discharging duct selectively communicated with the first supply duct or the second supply duct through the vent body.

2. The air vent of claim 1, wherein the central discharging duct is disposed between the first discharging duct and the second discharging duct, and the central discharging duct is not communicated with the first supply duct or not communicated with the second supply duct depending on operation of a valve.

3. The air vent of claim 1, wherein the first supply duct receives air that satisfies a first condition from the HVAC system, and the second supply duct receives air that satisfies a second condition from the HVAC system.

4. The air vent of claim 2, wherein a blade for guiding a direction of discharged air is disposed at an outlet of the central discharging duct, and the valve and the blade are rotatably connected by at least one link making a lever motion.

5. The air vent of claim 4, wherein the blade is a vertical blade for altering a direction of discharged air to right and left directions, and the links connecting the valve with the blade are sequentially connected such that a rotating direction of the blade is opposite to a rotating direction of the valve.

6. The air vent of claim 1, further comprising:
a vent knob provided to be handled by a passenger at an outlet of the central discharging duct;
a plurality of vertical blades vertically arranged at the outlet of the central discharging duct so as to alter a direction of discharged air to right and left directions by handling the vent knob;
a valve being operated so as to selectively communicate the central discharging duct with the first supply duct or the second supply duct; and
an operation link connecting the vertical blade with the valve such that the valve is operated according to operation of the vertical blade by handling the vent knob.

7. The air vent of claim 6, wherein the operation link comprises:
a first link rotatably connected with a first hinge member which is vertically protruded from a blade connecting member for connecting the vertical blades to be in synchronization with each other;
a second link rotatably connected with the first link; and
a third link rotatably connected with the second link and integrally moved together with the valve.

8. The air vent of claim 7, wherein the vertical blade, the first link, the second link and the third link sequentially make a lever motion by handling the vent knob, and the valve rotates together with the third link so as to selectively block the communication between the first supply duct and the central discharging duct or the communication between the second supply duct and the central discharging duct.

9. The air vent of claim 8, wherein the valve is formed in a wide plate shape so as to block the communication between the first supply duct and the central discharging duct or the communication between the second supply duct and the central discharging duct.
